(19) United States
(12) Patent Application Publication
(10) Pub. No.: US 2025/0084945 A1
(43) Pub. Date: Mar. 13, 2025

(54) TEST CAP

(71) Applicant: BOS Fabrication Engineering Services Pty Ltd, St Marys NSW (AU)

(72) Inventors: Mark MOODY, St Marys NSW (AU); Jurgen VAN DEN BOS, St Marys NSW (AU)

(21) Appl. No.: 18/292,547

(22) PCT Filed: Jul. 28, 2022
(86) PCT No.: PCT/AU2022/050796

§ 371 Date: Jan. 26, 2024

(30) Foreign Application Priority Data
Jul. 29, 2021 (AU) 2021902326

(51) Int. Cl. F16L 55/115; G01L 19/10

(52) U.S. Cl. CPC F16L 55/1152; G01L 19/10

(57) ABSTRACT

A test cap (100) for fluid pressure testing of pipework is described.

The test cap (100) comprises a body (30) releasably attachable to pipework, the body (30) having a chamber (la) capable of being in fluid communication with pipework when test cap (100) is attached to the pipework, and a pressure-sensitive indicator (4) for indicating the presence or absence of fluid in the chamber (la) or in the pipework, or a change of pressure in the chamber (la) or in the pipework, when the chamber (la) is in fluid communication with the pipework.

### TECHNICAL FIELD

The present invention relates to a test cap for fluid pressure testing of pipework. The invention is thought to be particularly suitable for end of line instalment applications for plumbing, building and construction pipework.

### BACKGROUND ART

The following discussion of the background art is intended to facilitate an understanding of the present invention only. The discussion is not an acknowledgement or admission that any of the material referred to is or was part of the common general knowledge as at the priority date of the application.

Currently, test caps are used in the plumbing industry for new constructions where piping has been installed. These caps seal the end of the pipework wherever it protrudes, to enable the utility service, ie. water or a gas such as a heating or cooking gas, to be available for testing purposes, before fittings such as, but not limited to, tap work are installed.

It is generally assumed that installation of the pipework has been carried out correctly and that the utility is reaching the end of the pipework at the time a test cap is applied. Once test caps are installed, testing should take place before further work such as installation of cladding, tiling and gyprock is carried out. In some instances however, testing has been known to take place after such installation is performed.

In order to determine whether the intended utility is reaching the end of the pipework, when turned on at the main, it is necessary to remove the test cap entirely, resulting in spillage which can be damaging to nearby unfinished surfaces such as gyprock and tiling. This also poses a health and safety risk.

It is a regular occurrence to find that the utility framework is faulty at the testing phase. If it is found that the pipework is not functional at the test stage, identifying the source of the blockage can be time-consuming and costly.

By way of explanation of the prior art in more detail, plumbers use existing end of line 20 mm thread caps that do not detect if air or water pressure, or if the connecting pipe is connected to the main incoming pipe, be that for supplying water or gas.

In plumbing this is known as a dead leg: a run of pipe work installed within a space such as a wall or ceiling but not actually connected to a primary source, such as the main water pipe that runs from a water meter into a house and feeds all of the bathrooms, kitchen and laundry.

For example however, if a new ensuite was to be installed and the plumber installed the pipework in the walls up into the ceiling, and then across to the main water pipe, but did not connect them, then for all intents and purposes the job looks complete. The problem unfortunately is that it has not in fact been connected as required.

This has been observed to occur often on large scale projects, such as apartment blocks or hospitals with multiple water points. The plumber installs pipe work, being either gas or water pipes, inside a timber or metal frame. Then at the end of the line a 20 mm diameter thread is installed that extends, generally by about 40 mm, out from the wall.

A plastic male/female end cap is then screwed onto the outwardly extending thread depending on the tapware or purpose, ice. a shower, a toilet, or a gas heater, all being 20 mm in diameter.

This pipework is then tested to hold pressure, or should be if done by a professional tradesman. It is then left under pressure, and gyprock walls or brick or fibro are installed with holes in them to allow threads to protrude out. Then in the case of bathrooms, water proofing and tiling are done, or in the case of kitchen cupboards are installed at any time during this process.

Quite regularly during these processes a screw is drilled into a pipe, affecting its integrity to hold water or natural gas. The plumber is recalled to reinstate a new pipe, and arguments can erupt over who should pay and who is at fault.

It is an intention of the present invention to address these shortcomings.

### SUMMARY OF INVENTION

The present invention provides in one embodiment a test cap for fluid pressure testing of pipework, the test cap comprising:

a body releasably attachable to pipework:

the body having a chamber capable of being in fluid communication with the pipework when the test cap is attached to the pipework, and a pressure-sensitive indicator for indicating the presence or absence of fluid in the chamber or in the pipework when the chamber is in fluid communication with the pipework.

The present invention provides in another embodiment a test cap for fluid pressure testing of pipework, the test cap comprising:

a body releasably attachable to pipework:

the body having a chamber capable of being in fluid communication with the pipework when the test cap is attached to said pipework, and a pressure-sensitive indicator for indicating a change in pressure in the chamber or in the pipework when the chamber is in fluid communication with the pipework.

A pressure-sensitive indicator according to the invention will accordingly be responsive to the presence or absence of fluid in the chamber or in the pipework, or to a change in pressure in the chamber or in the pipework, when the chamber is in fluid communication with the pipework.

Where there is an absence of fluid in the chamber or in the pipework, or if there is no change in pressure in the chamber or in the pipework, the response the pressure-sensitive indicator provides may be a static response.

Typically the fluid to be detected by the pressure-sensitive indicator will be a liquid, such as water, or a gas, such as a heating gas or air.

In one embodiment, the pressure-sensitive indicator is housed within the chamber.

The body of the test cap is preferably releasably attachable to the pipework by at least one connector engageable with at least one complementary connector associated with the pipework. An engageable connector according to the invention will typically be a threaded connector.

The body of the test cap may include opposed male and female members, each of which is independently releasably attachable to the pipework.

The pressure-sensitive indicator may provide a visual or audible indication of the presence or absence of pressure, or a change in pressure, within the chamber or in the pipework when the chamber is in fluid communication with the pipework.

Preferably, the pressure-sensitive indicator provides a visual indication of the presence or absence of pressure, or a change in pressure, within the chamber or in the pipework when the chamber is in fluid communication with the pipework.

In one embodiment, the visual indication comprises a toggle moveable in the chamber responsive to the presence or absence of pressure, or a change in pressure, within the chamber of in the pipework.

The toggle may in one embodiment comprise a sleeve moveable along a shaft within the chamber.

In another embodiment, the visual indication comprises a pin moveable in the chamber responsive to the presence or absence of pressure, or a change in pressure, within the chamber of in the pipework.

In these embodiments, if no pressure or pressure change is detected by the pressure-sensitive indicator, then the toggle will remain stationary.

In these embodiments, at least part of the chamber may be formed from a clear material to allow for visual access to the interior of the chamber whereby to provide a visible indicator of any movement or lack of movement, as the case may be, of the toggle responsive to the presence or absence of pressure, or a change in pressure, within the chamber of in the pipework.

The chamber may further include a spring to hold the toggle stationary, the presence of pressure or a change in pressure being sufficient to overcome the bias of the spring and to allow the toggle to move within the chamber, whereby to allow for an indication of the presence of pressure or change in pressure in the chamber.

The chamber may be divided into a pair of chambers, each of which is capable of being in fluid communication with pipework when the test cap is attached to the pipework, each of which houses a toggle and a spring.

In another embodiment, the pressure-sensitive indicator is electronically connectable to a remote device capable of receiving an electronic signal from the pressure-sensitive indicator.

The remote device may be any suitable device capable of receiving and translating an electronic signal into a visual or audible indication.

Typically the remote device will be a hand-held electronic device.

The test cap may in one embodiment be Bluetooth-enabled and/or fitted with a microchip, a microprocessor or the like to enable pairing with, or a message to be sent to an app on, a remote device such as an iPhone.

Accordingly if in one embodiment a test cap containing a pressure-sensitive indicator according to the invention is electronically enabled, such as via a detector or transmitter coupled to the test cap and capable of indicating the presence or absence of, or a change in pressure in chamber or in the pipework and communicating using short-wave wireless technology such as a Bluetooth connection with an electronic device such as a mobile phone, a visible or audible readout may be transmitted to the mobile phone indicating the presence or absence, or loss of, pressure in the chamber or the pipework.

This arrangement can enable an observer to be in a location which is within electronic range but remote from the in-situ location of the test cap.

The present invention accordingly provides a form of test cap, preferably for use with water and gas pipes, that has an indicator, typically a visual indicator, to allow any observer to determine whether a liquid or gas is present in the aperture when it is connected to pipework such as a pipe end.

By replacing a standard test cap with a test cap having a pressure-sensitive indicator according to the invention, an in-situ or remote sight check of the functionality of the pipework can be carried out as soon as the utility is connected to the main source.

Having indicating test caps according to the invention installed in part of or throughout the pipe framework is thought to provide for more accurate isolation of the location of a fault. Further, identifying non-functioning pipework earlier can result in a safer work environment, save time and reduce the cost of repair.

Furthermore, when the pipework does need to be used to carry out testing or for connection of fittings, any person can safely, efficiently and easily identify whether there is fluid or gas present in the pipework.

A principal characteristic of one embodiment of the present invention is accordingly the provision of an improved test cap which incorporates a visual indication system that makes it possible for any person to safely, easily and efficiently identify whether there is pressurised liquid or gas in a pipe to which the test cap is connected, as current types of test caps are opaque, and do not contain any indicator of the presence or absence of liquid or gas in the pipes to which they are attached.

In another aspect, a test cap can, in accordance with an embodiment of the present invention, comprise an apparatus with a male hollow fitting with external thread at one end and a female hollow section with internal thread at the opposite end connected by an indicator section.

Between the male fitting and the female section of this embodiment is an indicator section containing a toggle that will move when pressure from either liquid or gas is present in the chamber.

In this embodiment the chamber can be made from clear material to allow for visual access to the inside of the indicator section.

In this aspect the indicator section may contain two chambers, with one chamber providing an open connection to the male hollow fitting, and the other chamber providing an open connection to the female hollow section. Within each chamber is a toggle.

When there is no pressure received into the chamber from the end that is attached to the pipework (that is, either the male connection or the female connection, according to what suits the pipework installed) the toggle will remain in the area of the chamber marked to identify that there is no liquid or gas present.

If there is pressure received inside the chamber due to the presence of pressurised liquid or gas within the pipe the toggle will move to the area of the chamber marked to identify that there is liquid or gas present. Preferably, the toggle comprises a sleeve operating on a shaft within the chamber, with a spring providing an element of resistance against the toggle showing a false reading.

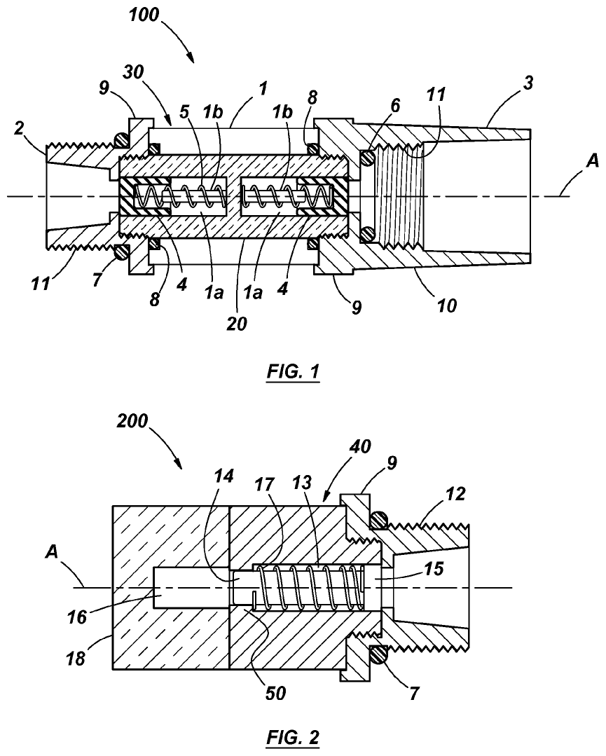

An example of the design of the end sections, indicator section and toggle is represented in FIG. 1.

In a further aspect, a test cap in accordance with the present invention could consist of only a male or only a female connection with a chamber as described above incorporated into the test cap to indicate the presence or absence of a liquid or gas.

This interpretation may otherwise employ a different means of indication, such as a pressure-sensitive pin apparatus or similar.

An example of an alternative adaptation of the improved design, incorporating a pin apparatus as a visual indicator, is shown in FIG. 2.

The test cap is preferably made from plastic or nylon, however other materials can also be used.

A number of types of flow indicators are known in the art. To the Applicant's knowledge they are however designed to be an in-line instalment, not an end of line instalment in accordance with the test cap of the present invention.

In any case, should either end of a known flow indicator be capped to provide for an end of line application, these would not function for the purpose of indicating the presence or absence of pressure due to liquid or gas. They are designed to indicate the rate at which a liquid or gas is flowing and would be static whether there was liquid or gas present or not. That is, zero flow in a full pipe would provide the same indication as an empty pipe.

### DESCRIPTION OF PREFERRED EMBODIMENTS

The invention may be better understood with reference to the illustrations of non-limiting embodiments of the invention in which:

FIG. 1 is an elevation of an improved test cap (100) according to the invention having a pressure-sensitive indicator, with parts connected as a completed assembly:

FIG. 2 is an elevation of a further aspect of an improved test cap (200) according to the invention in which a different mode of toggle system is employed as a pressure-sensitive indicator on a male-or female-only connection:

FIG. 3 is an isometric view of the improved test cap (100) of FIG. 1:

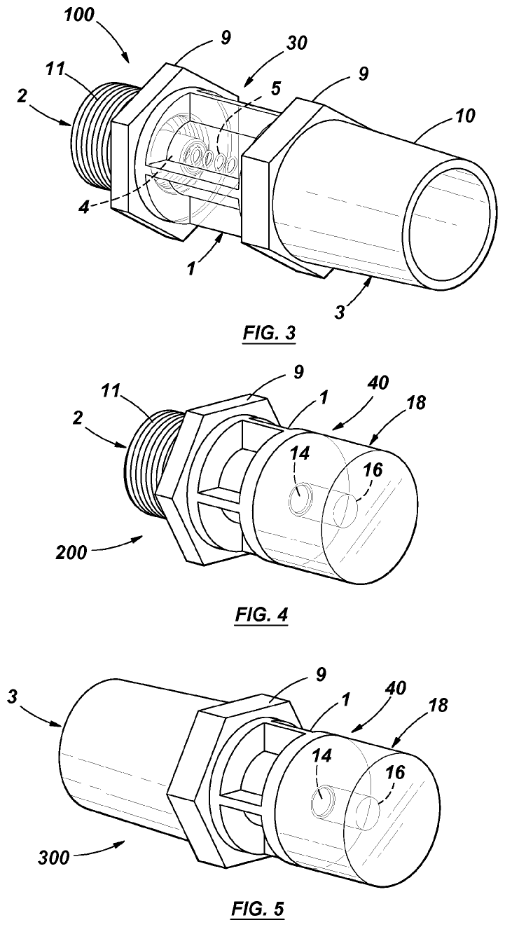

FIG. 4 is an isometric view of the improved test cap (200) of FIG. 2:

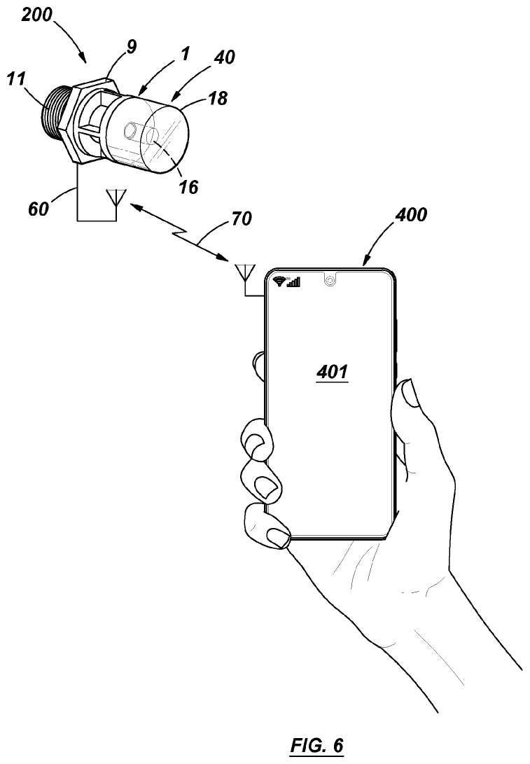

FIG. 5 is an isometric view of an improved test cap (300) of FIG. 2 having a female connector, and

FIG. 6 is a schematic view of an improved test cap (200) according to the invention which is electronically enabled.

The examples in the embodiments of FIGS. 1 to 5 show a test cap (100, 200, 300) for fluid pressure testing of pipework (not shown) having a body (30, 40) releasably attachable to the pipework, the body (30, 40) having a chamber (la, 13) capable of being in fluid communication with the pipework, when the test cap (100, 200, 300) is attached to the pipework.

In the embodiments shown, body (30, 40) is generally substantially cylindrical, although other body shapes can be readily contemplated within the spirit and scope of the invention.

A pressure-sensitive indicator in the form in the embodiments shown of a toggle system (20, 50) housed within chamber (la, 13) is provided for indicating, and being responsive to, the presence, or being non-responsive to the absence, of fluid in the chamber (la, 13), or for indicating and being responsive to, a change in pressure in the chamber (la, 13), when the chamber (la, 13) is in fluid communication with the pipework.

Test cap (100, 200, 300) is provided in the embodiments shown with a shaped flange (9) designed to correspond to a hand tool such as a spanner or similar (not shown) for the purposes of tightening the indicator test cap onto the pipe end. If desired the female connection section of the test cap may have outwardly disposed ribs or corrugations in the outer surface (10) to provide for secure grip when tightening by hand.

The improved test cap shown in FIG. 1 has a male connector (2) and a female connector (3) joined by a visually accessible indicator section (1) containing a pressure-sensitive indicator comprising a toggle system (20) having two chambers (la), each containing a shaft (1b) and a spring (5) and a sleeve (4). In the embodiment shown, sleeve (4) is in the form of a small hollow piston, closed on one side, and includes a cavity to secure the spring (5).

Visually accessible indicator section (1) will typically be formed from a clear or transparent material, such as a clear plastics material.

In the embodiment shown in FIG. 1, chambers (la) are not fluidly connected to each other, and are designed to operate independently of one another.

Each of opposed male connector (2) and female connector (3) is independently releasably attachable to pipework.

An advantage of incorporating into test cap (100) both a male connector (2) and a female connector (3) at either end and a pair of chambers (la) operating independently of one another is that either end of the test cap (100) may be attached to a pipe protrusion which has either a male or a female thread.

Either the male connector (2) or the female connector (3) accordingly seals onto the open end of the pipe to be tested (also not shown) by way of a thread (11) and an O-ring (6,7).

The hollow section of chamber (la) connects to the open end of the pipe to which the connector (2, 3) is threaded with an O-ring (8) providing a seal.

Once pressurised gas or liquid enters the chamber (la) the sleeve (4) of the toggle system (20) will overcome the pressure of the spring (5) and move along the shaft (1b) so that it enters into the clear section of the chamber (la) to indicate the presence of pressurised gas or liquid in the pipe.

It will be understood by those skilled in the art that a single chamber housing one sleeve (4) and one spring (5) and either a male connector (2) or a female connector (3) may be effectively employed to achieve the advantages of the test cap according to the invention shown in FIG. 1.

Sleeve (4) is preferably coloured to provide for easy identification by sight.

The alternative example shown in FIG. 2 employs the same inventive concept shown in FIG. 1 and as described herein incorporating a pressure-sensitive indicator, exemplified as one possible alternative design within the scope of the invention whereby the male or female connector (12) contains a chamber (13) in which is located a toggle system (50) comprising a pin (14) with a flanged base (15) of a diameter slightly less than the internal diameter of the chamber (13) and a spring (17).

A transparent disc (18) with a hollow section at the centre (16) of slightly larger diameter to that of the pin (14) is permanently fixed to the end of the connecter that is opposite to the connected pipe. Between the pin (14) of the toggle system (50) and the hollow section in the outer chamber (16) is a spring (17). Between the thread (12) and the chamber (13) is a shaped flange (9) designed to correspond to a hand tool such as a spanner or similar for the purposes of tightening the indicator test cap onto the pipe end.

An O-ring (7) is located between the thread (12) and the flange (9) for the purpose of sealing the connection to the pipe. When a liquid or gas enters the chamber, the pressure will activate the toggle system (50) at the base (15) such that the pin (14) will overcome the pressure of the spring (17) and move through the hollow section (16) causing the pin (14) to protrude into the hole (16) of transparent disc (18), thereby providing a visual indication of the presence of pressurised gas or liquid inside the test cap.

If desired the outer surface of the test cap (100, 200, 300) may have outwardly disposed ribs or corrugations (not shown) to provide for a secure grip when tightening by hand. The pin (14) is preferably coloured to provide for easy identification by sight.

In use, a test cap (100, 200, 300) according to embodiments of the invention is connected to an approximately 20 mm diameter thread installed in end of line pipework, the thread extending out from the wall by about 40 mm, via a male (2) or female connector (3) engaging with the complementary outwardly extending thread, thereby creating a fluid tight seal.

It will be appreciated that plural test caps (100, 200, 300) may be employed in a similar manner at any similar protruding thread point along the piping network.

A mains source of fluid, such as water or gas, such as a heating gas, is then opened so that a chamber (la, 13) of test cap (100, 200, 300) is in fluid communication with the mains source.

If a pressure change is detected, the sleeve (4) or pin (14) of toggle system (20, 50) will be displaced within the chamber (la, 13) by overcoming the bias of spring (5, 17).

The sleeve (4) or pin (14) of toggle system (20, 50) so displaced will then provide a ready visual indication of the presence of a pressure change to an observer.

Similarly, if no pressure is detected on the opening of the mains source, then the sleeve (4) or pin (14) of toggle system (20, 50) will remain stationary, also providing a ready visual indication of the absence of pressure to an observer.

If the test cap (100, 200, 300) containing a pressure-sensitive indicator according to the invention is electronically enabled, such as via a detector or transmitter (60) coupled to the test cap (100, 200, 300) and capable of indicating the presence or absence of, or a change in pressure in chamber (la, 13) or in the pipework and communicating using short-wave wireless technology such as a Bluetooth connection (70) with an electronic device such as a mobile phone (400) having a screen (401) as shown in FIG. 6 and a speaker (not shown) for delivering an audible signal such as an alarm, a visible or audible readout may be transmitted from test cap (200) to the mobile phone (400) indicating the presence or absence, or loss of, pressure in the chamber or the pipework. This can enable an observer to be in a location remote from the in-situ location of the test cap (100, 200, 300).

Those skilled in the art will readily understand the manner in which such a communication between test cap (100, 200, 300) and an electronic device such as mobile phone (400) may be established.

Typically, by way of example, test cap (100, 200, 300) may incorporate or be fitted with a microchip, a microprocessor or the like to facilitate communication or pairing with an electronic device.

With test caps having a pressure-sensitive indicator according to the present invention, when the pipework is initially installed and tested it will accordingly readily allow the plumber to be physically aware that their pipework is installed correctly and working and has no dead legs, as they can walk around and see that every thread pipe protruding from the wall has activated the indicator, thus providing a pressure indication.

A pressure-sensitive indicator according to the invention will also retract if pressure is lost (as the spring's bias will overcome the loss of pressure) due to a screw in a pipe, such as for example by a gyprocker puncturing a gas pipe extending down a wall in a living room with provision for a gas heater, or in the case of a noisy building site where no one can hear the test air leak or a slow, small leak.

A test cap having a pressure-sensitive indicator in accordance with the invention will also allow a builder, architect or anyone else associated with a building project to proceed with a task or to modify a task knowing that the pipe work is either sound or unsound, thus saving money and building assets from potential damage, such as water damage.

It will also allow tradesmen to know essentially instantly if they have not undertaken the job properly, or that there is, for example, pressure in a water line, and take appropriate steps to contain a water spill.

After tiles or a kitchen is ready for the installation of tapware, known as the fit-off stage, the plumber turns off the water source, installs the taps, toilet or gas taps, heater etc. as the case may be, and then goes around to each point and commissions them all to make sure they are working correctly.

This is usually the point at which it is detected that there is a dead leg, ie. one might have water to the kitchen, but not to the laundry.

This can occur in apartment blocks, as one person might start and install and then another person finishes it, and so in the run of things pipes don't get connected or can be cross connected.

The plumber then has to cut holes in walls or ceilings to locate the missed connection, resulting in more delays, costs, and damage to building assets.

A test cap according to the invention will either prevent, or at least reduce the likelihood, of this happening.

Throughout this specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

1. A test cap for fluid pressure testing of pipework, said test cap comprising:
a body releasably attachable to said pipework;
said body having a chamber capable of being in fluid communication with said pipework when said test cap is attached to said pipework, and
a pressure-sensitive indicator for indicating the presence or absence of fluid in said chamber or in said pipework when said chamber is in fluid communication with said pipework.

2. A test cap for fluid pressure testing of pipework, said test cap comprising:
a body releasably attachable to said pipework;
said body having a chamber capable of being in fluid communication with said pipework when said test cap is attached to said pipework, and
a pressure-sensitive indicator for indicating a change in pressure in said chamber or in said pipework when said chamber is in fluid communication with said pipework.

3. A test cap according to claim 1, wherein said pressure-sensitive indicator is housed within said chamber.

4. A test cap according to claim 1, wherein said fluid comprises a liquid or a gas.

5. A test cap according to claim 1, wherein said body is releasably attachable to said pipework by at least one connector engageable with at least one complementary connector associated with said pipework.

6. A test cap according to claim 5, wherein said engageable connector is threaded.

7. A test cap according to claim 5, wherein said body includes opposed male and female members, each of which is independently releasably sealable to an open end of pipework to be tested.

8. A test cap according to claim 1, wherein said pressure-sensitive indicator provides a visual indication of the presence or absence of pressure or a change in pressure within said chamber or in said pipework when said chamber is in fluid communication with said pipework.

9. A test cap according to claim 8, wherein said visual indication comprises a toggle moveable in said chamber responsive to the presence or absence of pressure or a change in pressure within said chamber or in said pipework.

10. A test cap according to claim 9, wherein said toggle comprises a sleeve moveable along a shaft in said chamber responsive to the presence or absence of pressure or a change in pressure within said chamber or in said pipework.

11. A test cap according to claim 9, wherein said toggle comprises a pin moveable in said chamber responsive to the presence or absence of pressure or a change in pressure within said chamber or in said pipework.

12. A test cap according to claim 9, wherein said chamber further includes a spring to hold said toggle stationary, the presence of pressure or a change in pressure being sufficient to overcome the bias of said spring and to allow said toggle to move within said chamber, whereby to allow for an indication of said presence of pressure or change in pressure in said chamber.

13. A test cap according to claim 12, wherein said chamber is divided into a pair of chambers, each of which is capable of being in fluid communication with said pipework when said test cap is attached to said pipework, each of which houses a toggle and a spring.

14. A test cap according to claim 12, wherein said chamber is at least partly formed from a clear material, whereby to provide for a visual indication of the presence of pressure or a change in pressure in said chamber or in said pipework when said chamber is in fluid communication with said pipework.

15. A test cap according to claim 9, wherein said toggle is retractable in response to a loss of pressure in said chamber or in said pipework.

16. A test cap according to claim 15, wherein said pressure-sensitive indicator is electronically connectable to a remote device capable of receiving an electronic signal from said pressure-sensitive indicator.

17. A test cap according to claim 16, wherein said remote device comprises a hand-held electronic device, a mobile phone, a computer or a laptop computer.

18. A test cap for fluid pressure testing of pipework, said test cap comprising:
a body releasably attachable to said pipework;
said body having a pair of chambers each of which is capable of being in fluid communication with said pipework when said test cap is attached to said pipework, and
a pressure-sensitive indicator for indicating the presence or absence of fluid or a change in pressure in at least one of said chambers or in said pipework when one or more of said chambers is in fluid communication with said pipework.

19. A test cap according to claim 18, wherein said body includes opposed male and female members, each of which is independently releasably and sealably connectable to an open end of pipework to be tested.
